(19) United States
(12) Patent Application Publication
(10) Pub. No.: US 2026/0097334 A1
(43) Pub. Date: Apr. 9, 2026

(54) Quick Change Compact Dental Amalgam Separator

(71) Applicant: The United States of America, as represented by the Secretary of the Navy, Silver Spring, MD (US)

(72) Inventors: Yoon Y. HWANG, San Antonio, TX (US); Dorian S. OLIVERA, San Antonio, TX (US); Justin P. BEQUETTE, San Antonio, TX (US); Meaghan A. ROSE, San Antonio, TX (US); Daniel W. THOMPSON, San Antonio, TX (US)

(21) Appl. No.: 19/343,805

(22) Filed: Sep. 29, 2025

Related U.S. Application Data
(60) Provisional application No. 63/704,271, filed on Oct. 7, 2024.

(51) Int. Cl. B01D 35/02; B01D 35/14; B01D 35/30

(52) U.S. Cl. CPC B01D 35/02; B01D 35/14; B01D 35/306; B01D 2221/10

(57) ABSTRACT

A dental amalgam separator operates to filter and trap mercury-containing waste, thus preventing the contamination of a downstream facility such as a municipal water treatment plant. The present invention employs a vertically-oriented pleated filter in a housing having an interior wall that tapers inward such that, at a bottom of the filter element, practically no space exists between the housing and the filter element. Such a design minimizes stagnant or void volume. This provides for an effective filter in a compact volume, thereby reducing disposal costs of the mercury-containing hazardous waste.

### CROSS-REFERENCE TO RELATED APPLICATIONS

This application claims the benefit of U.S. Provisional Application 63/704,271 filed on Oct. 7, 2025 the entirety of which is incorporated herein by reference.

### FEDERALLY-SPONSORED RESEARCH AND DEVELOPMENT

The United States Government has ownership rights in this invention. Licensing inquiries may be directed to NMRC OPBD, 503 Robert Grant Ave., Silver Spring, MD 20910-7500, or usn.detrick.nmrc.mbx.technology-transfer@health.mil, referencing NC 212263.

### BACKGROUND

Dental intervention for conditions such as tooth decay, caries, missing teeth, and periodontitis concern both military and civilian populations. Traditionally, treatment of caries involves filling the cavity with an amalgamation of different metals consisting of tin, silver, copper, zinc, and mercury, this material known as dental amalgam.

Amalgam contains approximately 50% mercury, which is classified as a hazardous waste component. Despite this, amalgam is durable and cost effective, making it a filling of choice for decades. Accordingly, wastewater from dental offices serves as a major source of mercury loading to publicly owned treatment works, accounting for approximately half of the total mercury loading. The EPA enacted a ruling under 40 Code of Federal Regulations (CFR) Part 441, effective July 2017, requiring the use of dental amalgam separators with ≥95% solids retention efficiency (SRE) in dental practices (all those in in which amalgam restoration placement and removal occurs more than occasionally) to trap amalgam in wastewater prior to release into local water systems.

The most affordable and widely used amalgam separator in military dental clinics is the DD2011 series chairside amalgam separator, also called the “Simple One.” While the fillable volume of these separators is approximately 360 cm³ and their expected longevity up to one year, as discussed below their operation and position design adversely impact actual costs. The DD2011 separators are large and must be placed at the back of the dental chair in a horizontal position (FIG. 1). The horizontal position prevents full draining, resulting in stagnation and furthermore reduces the filter life expectancy by half due to uneven particle distribution.

Because disposal costs are based on volume, these deficiencies result in substantial economic loss. While these separators are among the most affordable on the market when considering only acquisition cost, their disposal costs are directly dependent on separator size. A 5-gallon disposal bucket can contain five such spent separators for delivery to an incineration facility. With more than 117 military dental clinics using these products, assuming each clinic has at least 40 dental chairs, such as that seen at Logan Dental Clinic, Fort Belvoir, the annual cost for separator maintenance would exceed $1.4M. However, these costs can be expected to increase substantially when the number of recruits being processed, total workload, and halved filter utilization is considered.

A need exists for a compact, efficient, and cost-effective amalgam separator for use in dental clinics to reduce annual maintenance costs.

### BRIEF SUMMARY

In one embodiment, a dental amalgam separator comprises an cartridge housing configured to enclose a replaceable hollow cylindrical filter element in a vertical orientation, with a space between the filter element and an interior wall of the cartridge housing; a removable upper external housing configured to seal upper and lower portions of the cartridge housing via gaskets, the upper external housing comprising one or more inlet ports in fluidic communication with an outside of the filter element; and a removable lower external housing configured to close against a lower portion of the cartridge housing and in contact with the filter element, the lower external housing comprising an outlet port in fluidic communication with an inside of the filter element, wherein, in a region comprising the lower portion of the cartridge housing, the housing interior wall tapers inward such that, at a bottom of the filter element, practically no space exists between the cartridge housing and the filter element, thus minimizing void volume; and wherein the inlet and outlet ports are sized to fit conventional dental systems, and whereby application of suction to the outlet port draws fluid from the one or more inlet ports through the filter element and into the outlet port, thereby trapping suspended amalgam from the fluid in the filter element.

### BRIEF DESCRIPTION OF THE DRAWINGS

FIGS. 1A and 1B depict a DD2011 series amalgam separator on A-dec dental chair (FIG. 1A) with a diagram (FIG. 1B) depicting internal wastewater flow behavior, with unfiltered liquid pooled in the void volume below the filter.

FIG. 2 illustrates an exemplary dental amalgam separator as described herein.

FIG. 3A shows an A-Dec® 500 dental chair with DD2011 amalgam separator on the back of the chair secured with brackets. FIG. 3B depicts the “Mini One,” an exemplary amalgam separator attached at the receptacle point for the three suction devices. FIG. 3C provides an occupied space comparison between the “Simple One” and the “Mini One” amalgam separators.

FIGS. 4A-4C depict an exemplary amalgam separator with removable cartridge containing 10-micron filter, essentially the same unit as shown in FIG. 2. FIG. 4A provides a cutaway view of the assembled unit, FIG. 4B shows the assembled unit, and FIG. 4C is an exploded view.

FIGS. 5A and 5B are images showing the scale of a separator as described herein compared to the prior art DD2011 amalgam separator. FIG. 5A shows with dimensions of the DD2011 amalgam separator in comparison to the individual cartridge and housing for the “Mini One” amalgam separator. FIG. 5B makes a size comparison of both disposable portions which are typically disposed inside a five-gallon bucket.

### DETAILED DESCRIPTION

### Definitions

Before describing the present invention in detail, it is to be understood that the terminology used in the specification is for the purpose of describing particular embodiments and is not necessarily intended to be limiting. Although many methods, structures, and materials similar, modified, or equivalent to those described herein can be used in the practice of the present invention without undue experimentation, the preferred methods, structures, and materials are described herein. In describing and claiming the present invention, the following terminology will be used in accordance with the definitions set out below.

As used herein, the singular forms “a”, “an,” and “the” do not preclude plural referents, unless the content clearly dictates otherwise.

As used herein, the term “and/or” includes any and all combinations of one or more of the associated listed items.

As used herein, the term “about” when used in conjunction with a stated numerical value or range denotes somewhat more or somewhat less than the stated value or range, to within a range of +10% of that stated.

### Overview

Current DD2011 amalgam separators are attached to the dental chair with large tubing on the back or under a floor plate. The amalgam separator described herein offers a compact alternative that is out of the way, cheaper to maintain, and easy to install.

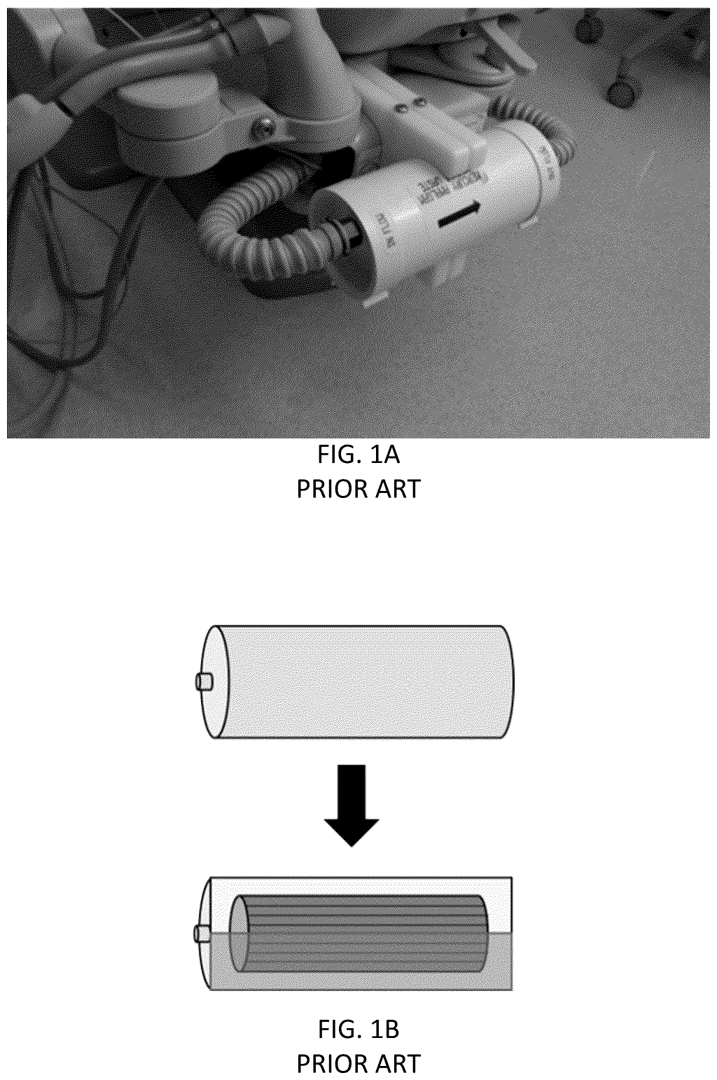

As seen in FIGS. 1A and 1B, the prior art DD2011 amalgam separator is relatively bulky and due to the horizontal mounting, suffers from pooling with an uncollectable void volume at the bottom of the housing.

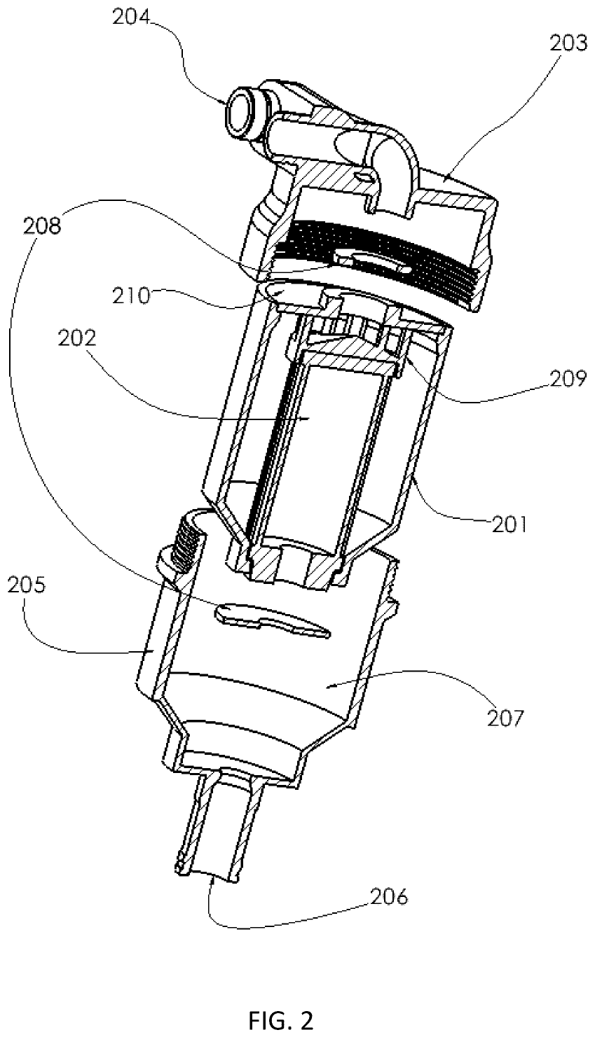

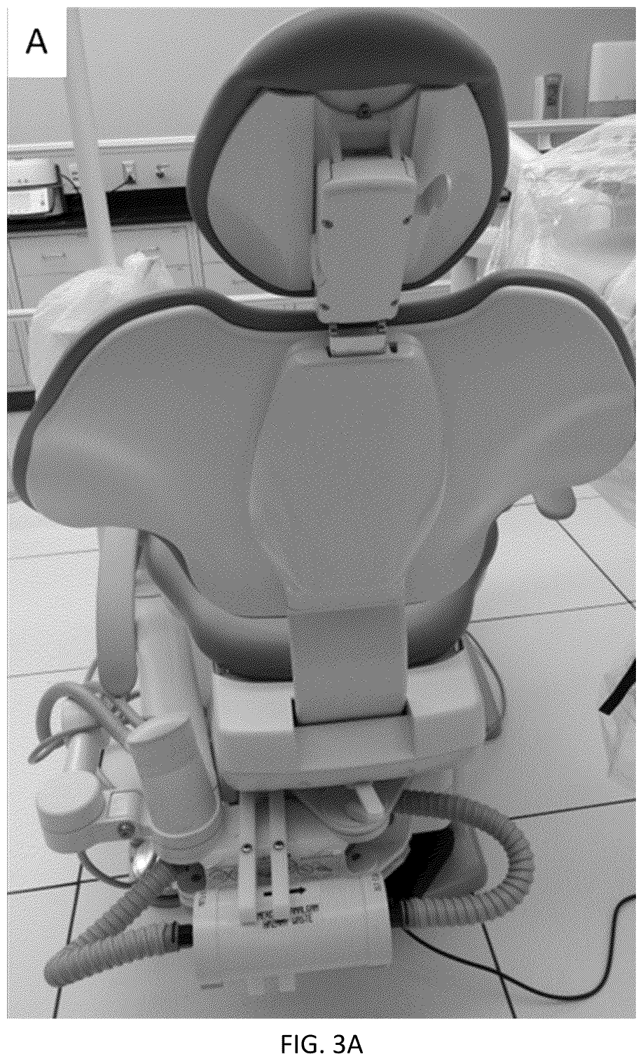

In contrast, the exemplary separator depicted in FIG. 2 made according to the present design avoids these problems. A replaceable filter cartridge (201, 202, 207, 209, & 210) has a cartridge housing (201, 207, & 210) enclosing a hollow cylindrical filter element 202 in a substantially vertical orientation, with a space between the filter element and an interior wall of the cartridge housing. Diverter 209 between the filter element 202 and the top 210 of the internal cartridge 201 acts to direct incoming fluid to the sides of the filter element and furthermore serves as a spacer to ensure that the filter element 202 is sealed and retained in place. Optionally, the top 210 is permanently fixed (i.e., cannot be removed non-destructively) to the inner housing 201.

The exemplary separator of FIG. 2 further features a removable upper external housing 203 configured to seal against an upper portion 210 of the cartridge housing, with the upper external housing comprising one or more inlet ports 204 in fluidic communication with an outside of the filter element. A removable lower external housing 205 closes against the corresponding upper external housing 203 and contacts a lower portion of the filter element 202 exposed at the bottom of the cartridge housing. The lower external housing 205 comprises an outlet port 206 in fluidic communication with an inside of the filter element. Crucially, in a region 207 comprising a lower portion of the cartridge housing, the housing interior wall tapers inward such that, at a bottom of the filter element, practically no space exists between the housing and the element, thus minimizing void volume. The inlet 204 and outlet 205 ports are sized to fit conventional dental systems. Application of suction to the outlet port draws 206 fluid from the one or more inlet ports 204 through the filter element 202 and into the outlet port 206, thereby trapping suspended amalgam from the fluid in the filter element 202. Gaskets 208 aid the sealing of the filter element in the apparatus. Optionally, the upper external housing and lower external housing can join together via a threaded interface.

The inlets and outlets can be sized to dental industry standards. For example, the one or more inlets can be designed to fit A-dec® chair tools while the outlet designed to attach to an A-Dec® chair suction outlet. In embodiments, input ports have an outside diameter of ¾″ and the outlet port has an outside diameter of 1″. In further embodiments, the inlet port has an inside diameter of 15/32″ and the outlet port has an inside diameter of ⅝″.

Similarly, for ease of mounting, the external diameter created by external housings 203 and 205 can be the same as same diameter as that of A-Dec® coarse filter. Thus, in one embodiment, these housings have an external diameter of about 91 mm.

### Example

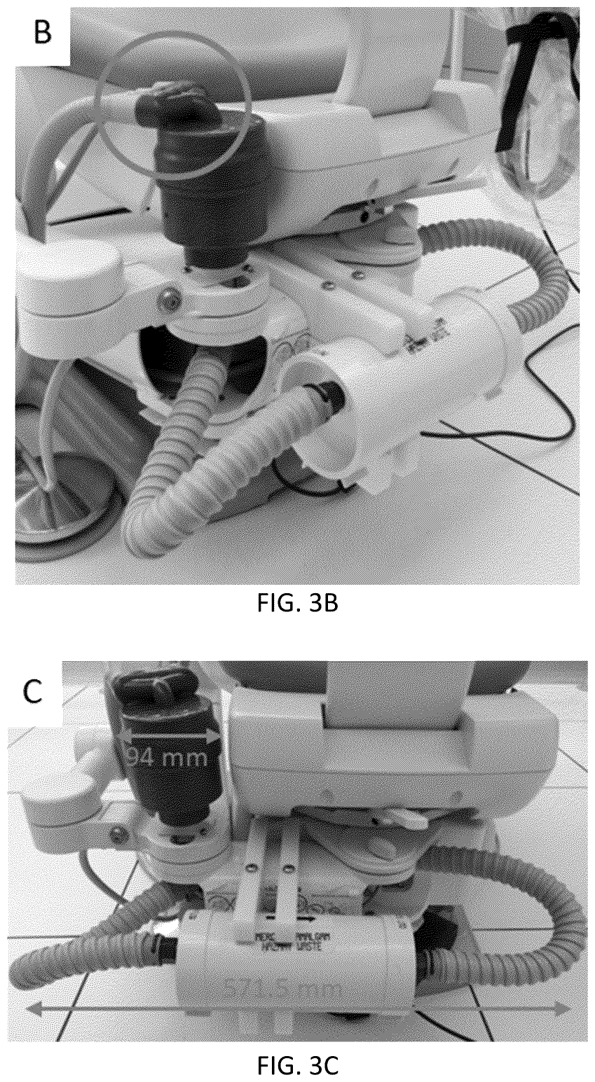

As a reduction to practice, the “Mini One” separator was 3D printed and tested. The separator offers a quick change, vertically positioned amalgam separator with +99% solids retention efficiency while being one third the size of a standard DD2011 separator. The Mini One may be directly installed on the side of the A-Dec® dental chairs with no additional plumbing or labor required (FIGS. 3A-3C).

The replaceable filter element 202 in this case is commercially available with model designation SE-R-10PP, a pleated filter element with a pore size of 10 microns. One may easily substitute for a different filter by changing the dimensions of the design. The filter element is housed substantially vertically, thus preventing water pooling or stagnation. This desirably provides the system with a low void volume or dead volume of liquid that does not pass through the filter.

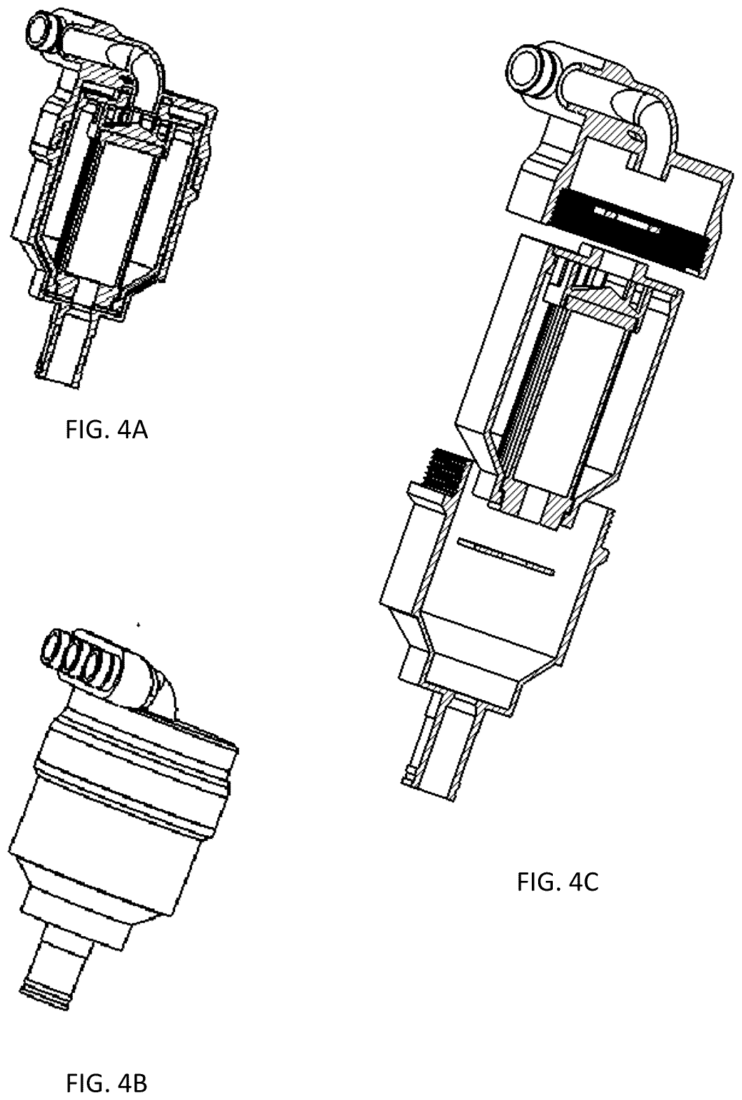

The “Mini One” cartridge housing holds a filter element, and these together may be removed and sealed for disposal at a fraction of the cost and effort of previously used separators. In one embodiment, the separator is designed to attach directly into the side of the A-Dec® dental chair system with ports to receive waste materials from all three of the associated dental suction devices. The external housing has input port diameter of ¾″ and an outlet port diameter of 1″. While these dimensions fit perfectly in the A-Dec® dental chair systems, they also match the dimension to connections on other amalgam separator brands ACADIA/ACADIA PLUS amalgam separator, ECO II, AND NXT HG5. Such connections and adaptors are already in place for dental waste handling systems and facilitate the plug-and-play modality of EPA-approved amalgam separators for installation at conventional dental chairs and stand-alone delivery systems. Waste materials pass from the top and are filtered through an internal chamber containing a 10-micron pore filter element as seen in FIG. 4.

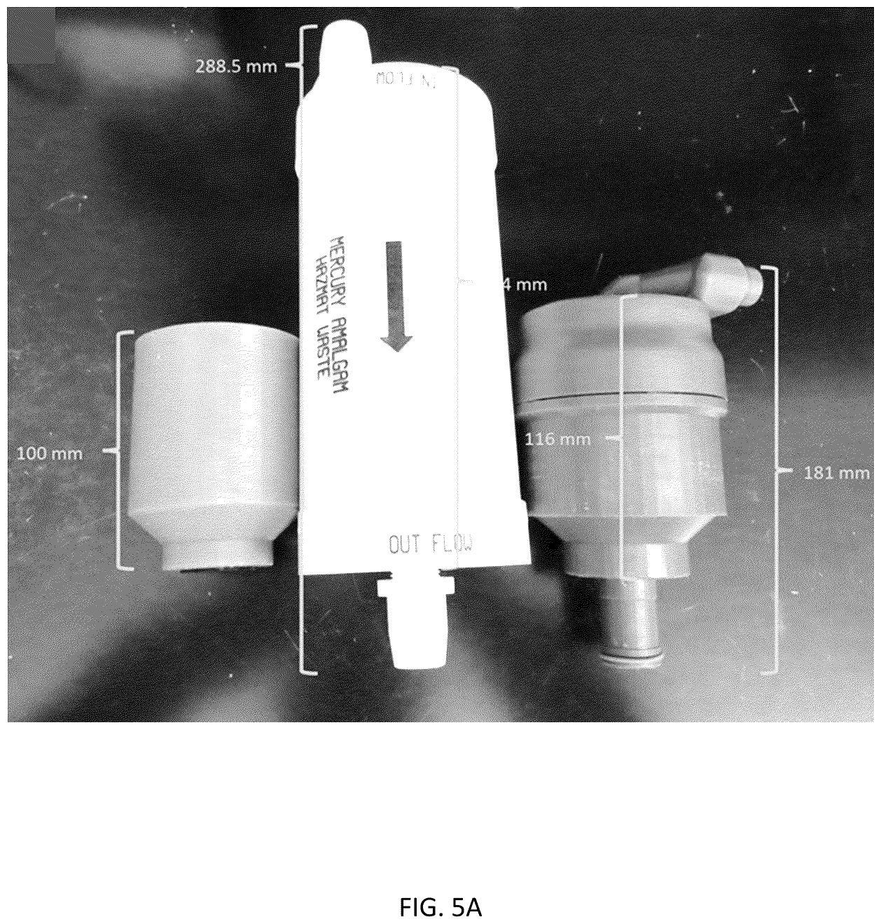

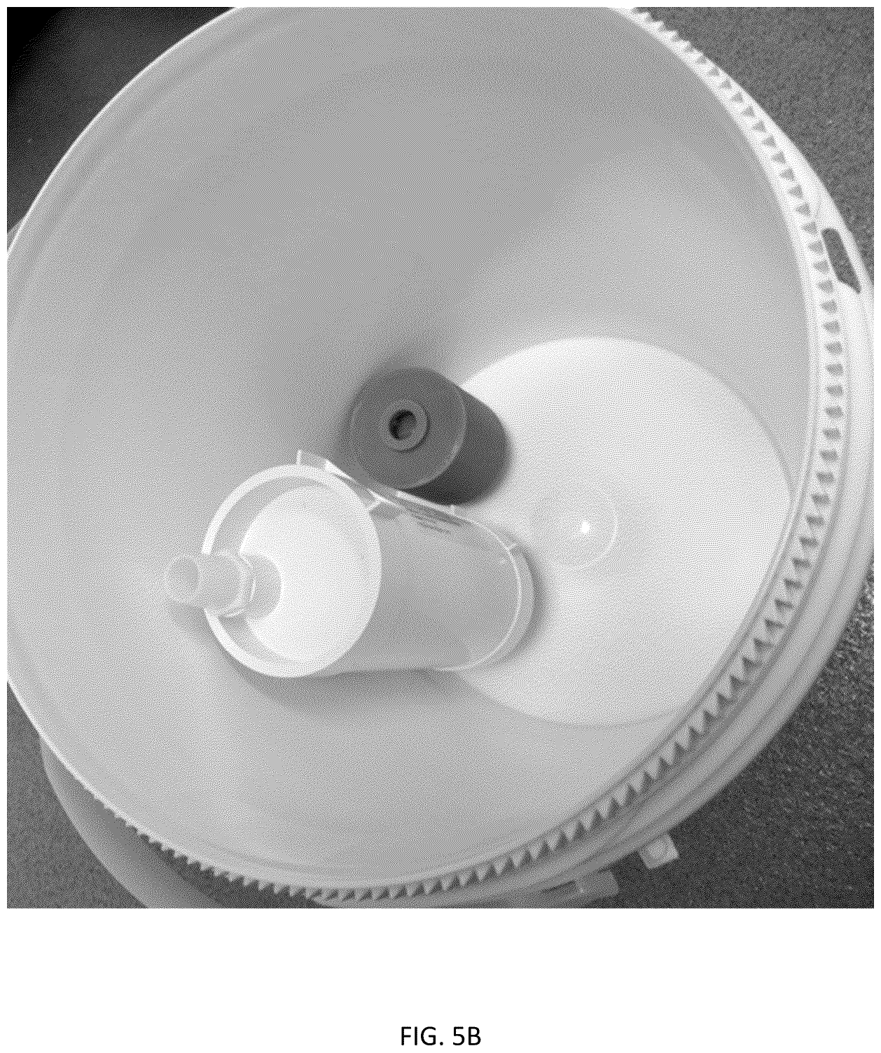

This exemplary “Mini One” allows for essentially complete entrapment of amalgam-containing wastes within a 178 cm³ fillable volume while preventing stagnation and unused filter capacity. Amalgam separator disposal costs are nearly entirely dependent on the volume of separators to be processed, with each prepaid 5-gallon bucket being advertised to hold a maximum of five separators from the prior art “Simple One” DD2011. The compact size of the present “Mini One” separator has the potential to reduce disposal costs by one third, as can be seen in FIGS. 5A and 5B, while increasing filter longevity.

### Further Embodiments

Optionally, the separator can include a pressure sensor to help determine when the filter is clogged and needs to be replaced.

While it is contemplated that the cartridge housing with its cap will be disposed of together with the filter element, in some embodiments only the filter element is disposed of, and the other components are reused at least once.

As noted above, the dimensions in the example can easily be modified to accommodate other filter elements.

### Concluding Remarks

All documents mentioned herein are hereby incorporated by reference for the purpose of disclosing and describing the particular materials and methodologies for which the document was cited.

Although the present invention has been described in connection with preferred embodiments thereof, it will be appreciated by those skilled in the art that additions, deletions, modifications, and substitutions not specifically described may be made without departing from the spirit and scope of the invention. Terminology used herein should not be construed as being “means-plus-function” language unless the term “means” is expressly used in association therewith.

What is claimed is:

1. A dental amalgam separator comprising:
an cartridge housing configured to enclose a replaceable hollow cylindrical filter element in a substantially vertical orientation, with a space between the filter element and an interior wall of the housing;
a removable upper external housing configured to seal against an upper portion of the cartridge housing, the upper external housing comprising one or more inlet ports in fluidic communication with an outside of the filter element; and
a removable lower external housing configured to close against upper and lower portions of the cartridge housing via gaskets and in contact with the filter element, the lower external housing comprising an outlet port in fluidic communication with an inside of the filter element,
wherein, in a region comprising the lower portion of the cartridge housing, the cartridge housing interior wall tapers inward such that, at a bottom of the filter element, practically no space exists between the cartridge housing and the filter element, thus minimizing void volume; and
wherein the inlet and outlet ports are sized to fit conventional dental systems, and
whereby application of suction to the outlet port draws fluid from the one or more inlet ports through the filter element and into the outlet port, thereby trapping suspended amalgam from the fluid in the filter element.

2. The separator of claim 1, wherein, when the separator is assembled, the upper external housing and lower external housing join together via a quarter-turn threaded interface, thereby enclosing the housing.

3. The separator of claim 1, wherein the separator has an outside diameter between about 85 mm and 100 mm, and the separator has an overall length of less than 300 mm.

4. The separator of claim 1, wherein said replaceable cylindrical filter element comprises a pleated and/or woven element with a pore size of 10 microns.

5. The separator of claim 4, wherein said element has an overall length of between 70 mm and 85 mm and an exterior diameter of between 35 mm and 45 mm.

6. The separator of claim 1, further comprising top and bottom gaskets sealing the filter element.

7. The separator of claim 1, wherein said one or more inlet ports housing input port comprise an outside diameter of ¾″ and said outlet port has an outside diameter of 1″.

8. The separator of claim 1, further comprising a pressure sensor configured to provide an indication when said filter element is clogged.
